(19) United States
(12) Patent Application Publication
(10) Pub. No.: US 2022/0193607 A1
(43) Pub. Date: Jun. 23, 2022

(54) SOLIDS REACTOR, SYSTEM, AND METHOD FOR SEPARATING OUT CARBON DIOXIDE, IN PARTICULAR FROM WASTE GASES

(71) Applicant: OTTO-VON-GUERICKE-UNIVERSITAET MAGDEBURG, Magdeburg (DE)

(72) Inventor: Eckehard Specht, Hamburg (DE)

(21) Appl. No.: 17/441,876

(22) PCT Filed: Mar. 20, 2020
(86) PCT No.: PCT/EP2020/057791

§ 371 Date: Sep. 22, 2021

(30) Foreign Application Priority Data
Mar. 22, 2019 (DE) 10 2019 107 440.1

(51) Int. Cl. B01D 53/82; B01D 53/62; B01D 53/34; B01D 53/96; B01J 8/02; B01J 19/00; B01J 20/04; B01J 20/28; C09K 5/16; F28D 20/00

(52) U.S. Cl. CPC B01D 53/82; B01J 2220/42; B01D 53/343; B01D 53/96; B01J 8/0285; B01J 19/0013; B01J 8/0278; B01J 20/041; B01J 20/043; B01J 20/28004; B01J 20/28016; C09K 5/16; F28D 20/0056; B01D 2251/404; B01D 2251/602; B01D 2251/402; B01D 2257/504; B01D 2258/0233; B01J 2208/024; B01J 2208/00389; B01J 2208/00203; B01J 2208/00539; B01J 2220/56; B01D 53/62

(57) ABSTRACT

Described herein is a system (100) for storage and releasing of carbon dioxide comprising at least one solids reactor (1), at least one compressor (7, 8) for compressing the carbon dioxide-containing gas or fluid, respectively, which is introduced through the inlet (3) of the solids reactor,
wherein the compressor (7, 8) is constructed in such a way that it adiabatically expands the gas or fluid, respectively, depleted of carbon dioxide that is discharged from the reactor by means of the outlet (2) of the solids reactor, and at least one countercurrent recuperator (6), which is constructed for the heat exchange of the compressed exhaust gas or fluid, respectively, that contains carbon dioxide and the gas or fluid, respectively, depleted of carbon dioxide.

Described is furthermore a solids reactor for storage and releasing carbon dioxide, comprising a gas-tight or fluid-tight, respectively, housing, which has an interior, at least one inlet for feeding in fluids and at least one outlet for discharging of gases or fluids, respectively, wherein the interior of the housing is filled with at least two different solids, wherein one solid is provided for storing thermal energy and the other solid is provided for regenerative storage and releasing of carbon dioxide.

Furthermore described is a method for storage and releasing of carbon dioxide.

The present invention relates to a solids reactor, a system and a method for separating carbon dioxide from exhaust gases with internal recovery of the reaction enthalpy.

To avoid climate change, it is necessary to isolate the gas carbon dioxide produced by combustion from the combustion products or to reuse it.

Most diverse methods and devices are described for this purpose in the prior art.

Carbon dioxide can be separated from exhaust gases if these are passed over lime particles (CaO) (calcium looping). The carbon dioxide then reacts according to CaO+CO₂—>CaCO₃ to limestone (CaCO₃). The CO₂ must be expelled from the limestone formed in accordance with CaCO₃—>CaO+CO₂. This is provided for with the previous methods by burning a fossil fuel with pure oxygen. Pure oxygen is necessary, otherwise the CO₂ would again be contaminated with air. Combustion with pure oxygen is always energy-intensive. Furthermore, additional carbon dioxide is generated.

For example, EP 2 644 256 A1 describes a method and a device for efficient carbon dioxide separation. There, the calcination and carbonization are carried out in different parts of the plant, with solids contained in the respective parts of the plant having to be transferred alternately. In WO 2005/046862 A1 furthermore a method is described for reactivating absorbents made from limestone by means of carbon dioxide. WO 2005/046863 A1 also describes a pre-treatment of absorbents made of limestone by hydration. The methods known in the prior art have considerable disadvantages, since they are very energy-intensive. The number of regeneration cycles for the limestone is also relatively small.

The object of the present invention is therefore to provide a solids reactor as well as a system which overcomes the disadvantages of the prior art and enables an energy-efficient separation of carbon dioxide from combustion products.

The object is solved by providing a solids reactor according to the main claim of the present invention. The object is also solved by providing a system which comprises at least one solids reactor according to the invention in accordance with the main claim. Furthermore, the object is achieved by providing a method according to the secondary main claim.

The object of the present invention is a solids reactor for storage and releasing carbon dioxide, comprising a gas-tight or fluid-tight housing, respectively, which has an interior, at least one inlet for feeding in fluids, in particular carbon dioxide-containing exhaust gases, and at least one outlet for discharging of fluids, in particular gases depleted of carbon dioxide, wherein the interior of the housing is filled with at least two different solids, wherein one solid is provided for storing thermal energy and the other solid is provided for reversible storage and releasing of carbon dioxide.

According to the invention, a solids reactor is preferred, wherein the housing further comprises components which are constructed for introducing or discharging the solids.

In particular, according to the invention a solids reactor is preferred, wherein in the area of the inlet and in the area of the outlet of gases or fluids, respectively, shut-off devices are arranged, which are constructed to change the pressure in the interior of the solids reactor, and/or to introduce gases or fluids, respectively, into the solids reactor and/or to discharge gases or fluids, respectively, from the solids reactor.

Particularly preferred is a solids reactor according to the invention, wherein the solids selected for the storage and releasing of carbon dioxide are selected from calcium oxide and calcium oxide-containing substances selected from limestones and dolomites or dolomite stones. It is provided according to the invention that the solids to be used are burned beforehand, if necessary, in order to enable the absorption of the carbon dioxide.

A solids reactor is also particularly preferred, wherein the solids for storing thermal energy are selected from inert mineral materials such as quartz, granite, silicon dioxide, igneous rocks, silicon carbides, zirconium oxides, metallic phase change materials, cast iron, grey cast iron or mixtures of the materials mentioned.

According to the invention, a solids reactor is preferred, wherein the at least two different solids are in the form of coated solids, consisting of an outer coating and an inner core, wherein the inner core is intended to store the thermal energy and the outer coating is provided for the reversible storage and release of carbon dioxide.

Here, it is particularly preferred that the double salts are selected from dolomite, dolomite stone, dolomitic rocks, rocks containing dolomite or dolomite stone, respectively, or the mixtures thereof.

According to the invention, a solids reactor is particularly preferred, wherein the at least two different solids are in the form of double salts, wherein one of the salts of the double salt is suitable for storing thermal energy and the other salt of the double salt is suitable for reversible storage and release of carbon dioxide. Here, it is particularly preferred that the double salts are selected from dolomite, dolomite stone, dolomitic rocks, rocks containing dolomite or dolomite stone, respectively, or the mixtures thereof.

Also preferred according to the invention is a solids reactor, wherein the at least two different solids have a particle size which is in the cm range.

Furthermore preferred is a solids reactor, wherein the solids introduced into the solids reactor form a fixed bed that allows through-flow.

Another object of the present invention is a system for storing and releasing carbon dioxide, comprising at least one solids reactor, at least one compressor for compressing the carbon dioxide-containing fluid or exhaust gas, respectively, which is introduced through the inlet of the solids reactor, wherein the compressor is constructed in such a way that it adiabatically expands the gas or fluid, respectively, depleted of carbon dioxide, that is discharged from the reactor by means of the outlet of the solids reactor, and at least one countercurrent recuperator, which is constructed for the heat exchange of the compressed fluid or exhaust gas, respectively, that contains carbon dioxide and of the gas or fluid, respectively, depleted of carbon dioxide.

Particularly preferred is a system according to the invention, wherein at least one feed device for heated fluids is arranged in the area of the inlet in order to further heat the carbon dioxide-containing fluid after heating in the countercurrent recuperator and before entering the inlet of the solids reactor.

Furthermore, a system is preferred, wherein one or more compressors is/are provided which compresses or compress and burn air and/or natural gas and/or heating oil and inject the combustion gas via the supply device.

A system is also preferred in which the feed device is electrically heatable and the fluid fed in is hydrogen gas.

Particularly preferred is a system in which furthermore pipelines and shut-off devices are also provided which allow the solids reactor to be constructed to be decoupled from the system, and which connect the solids reactor fluidically via the outlet for discharging gases or fluids, respectively, to the recuperator.

Furthermore, a system according to the invention is particularly preferred, wherein the system has at least two solids reactors, wherein the solids reactors are gas-technically or fluidically connected to the components of the system in such a way that the respective solids reactors are provided independently of one another for storing or releasing carbon dioxide.

The object of the present invention is also a method for storage and releasing of carbon dioxide, wherein one

a) provides at least one solids reactor for storing and releasing carbon dioxide,

b) introduces an exhaust gas or fluid, respectively, containing carbon dioxide, into the solids reactor, wherein on compresses the exhaust gas or fluid, respectively, in such a way that the partial pressure of the carbon dioxide is 1 to 2 bar,

c) stops the introduction of the carbon dioxide-containing exhaust gas or fluid, respectively, when the temperature inside the solids reactor is 910 to 960° C.,

d) releases the tension of the solids reactor to a pressure of 0.1 to 0.5 bar, after reaching the internal temperature of 910° C. to 960° C.,

e) discharges the carbon dioxide released again by the expansion from the solids reactor until the temperature inside the solids reactor is 810 to 850° C.,

f) compresses the discharged carbon dioxide to normal pressure and stores it.

Here it is particularly preferred that the partial pressure of the carbon dioxide in step b) is above 1 bar.

It is also particularly preferred that the pressure in the interior of the solids reactor in step d) is less than 0.4 bar, particularly preferred less than 0.2 bar.

It is also particularly preferred that the temperature in the interior of the solids reactor in step c) is more than 910° C.

It is also particularly preferred that the temperature in the interior of the solids reactor in step e) is below 850° C.

A method is also preferred wherein the storage of the carbon dioxide and the subsequent releasing take place in the same temperature range and in the same reactor.

A method is also preferred wherein the enthalpy released during carbon dioxide absorption or during storage, respectively, causes the temperature increase and is thereby stored in the material which remains inert.

A method is also preferred wherein the stored heat is reused after the pressure reduction for the releasing of the carbon dioxide.

The present invention is explained in more detail with the accompanying drawings. It shows:

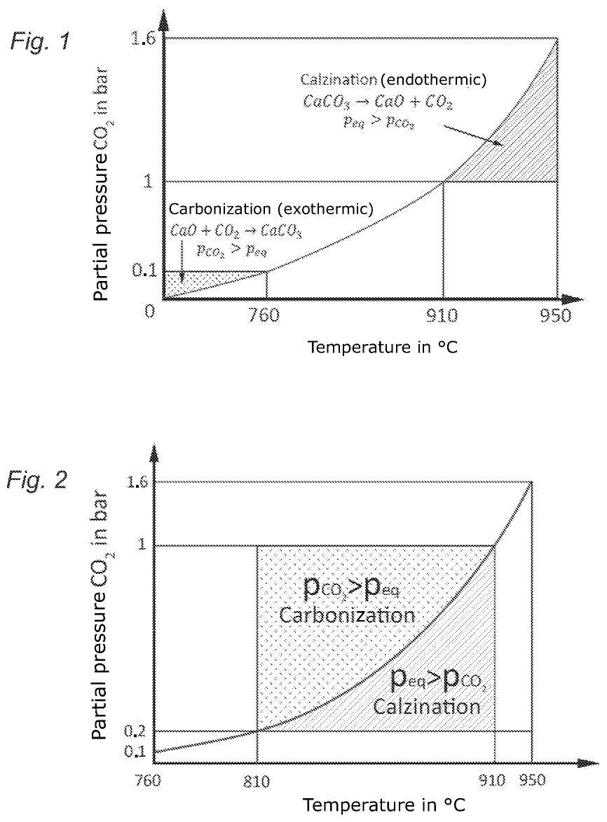

FIG. 1 an equilibrium curve p_{eq} for the calcination and the carbonization with reaction areas at ambient pressure;

FIG. 2 an equilibrium curve p_{eq} for the calcination and the carbonization with reaction areas at excess pressure of the exhaust gas and low pressure of the carbon dioxide gas;

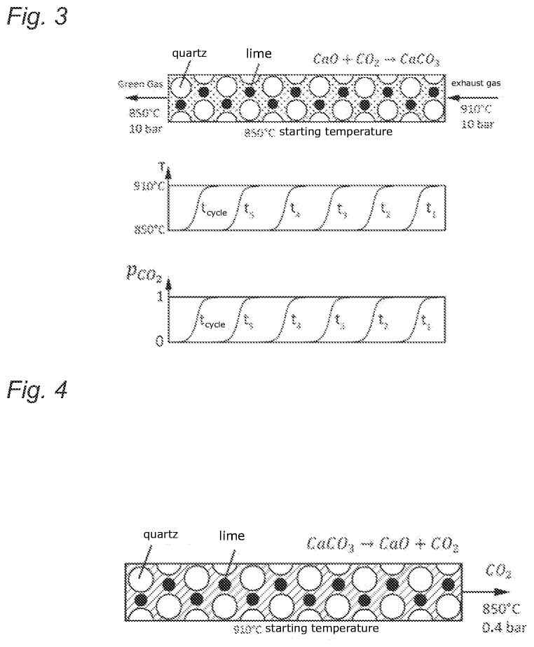

FIG. 3 a first embodiment of a solids reactor during carbonization with basic temperature and partial pressure profiles;

FIG. 4 a first embodiment of a solids reactor during calcination;

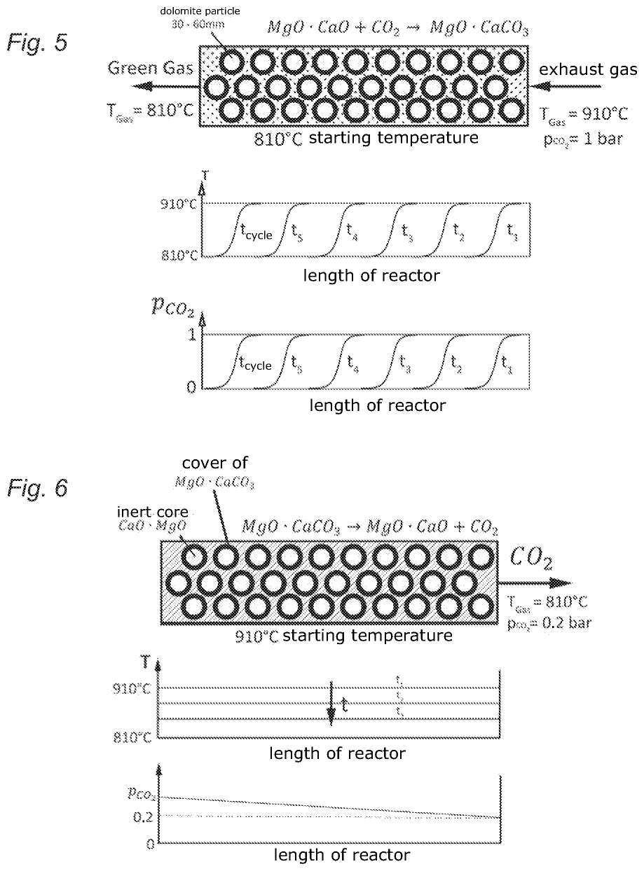

FIG. 5 a second embodiment of a solids reactor during the carbonization with basic temperature and partial pressure profiles

FIG. 6 a second embodiment of a solids reactor during the calcination with basic temperature and partial pressure profiles

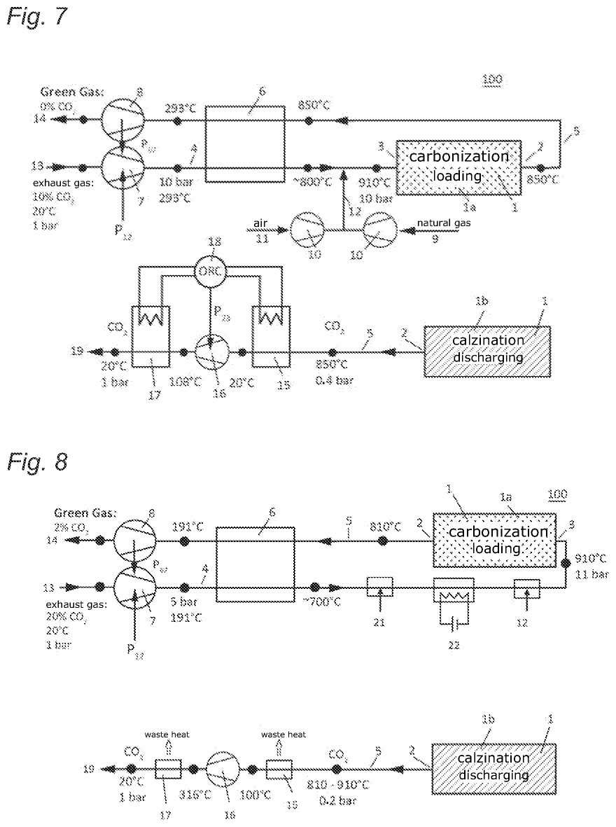

FIG. 7 a first embodiment of a scheme of a plant for carbonization and calcination;

FIG. 8 a second embodiment of a scheme of a plant for carbonization and calcination; and

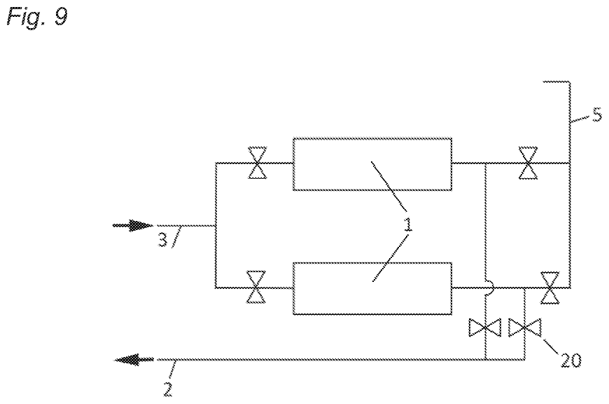

FIG. 9 partial view of a scheme of a plant with an arrangement of the solids reactors for parallel operation.

The carbon dioxide reacts according to the chemical equation CaO+CO₂—>CaCO₃ to limestone (CaCO₃). In FIG. 1 the equilibrium curve of this reaction is shown. For this so-called carbonization reaction, the partial pressure of the CO₂ must be above the equilibrium pressure. For example, if the partial pressure in the exhaust gas is 0.1 bar, i.e. 10% by volume of CO₂, the temperature of the lime (CaO) must be below 760° C. The carbonization reaction is exothermic. The heat released can therefore only be used in other processes that take place well below 760° C. The use of the heat is thus restricted. For example, the heat can be used for generation of steam and then be converted into electricity by means of a turbine.

The CO₂ must be expelled again from the limestone formed in accordance with CaCO₃—>CaO+CO₂. For this so-called calcination, the equilibrium pressure must be higher than the partial pressure. In the case that it is intended to generate pure CO₂ of one bar (ambient pressure), the temperature of the particles must therefore be above 910° C., as this is the temperature for the equilibrium pressure of 1 bar. The calcination is endothermic, so heat is required namely at a temperature level above 910° C.

With the process according to the invention and the solids reactor, carbon dioxide can be separated from combustion gases with considerably less energy than with the existing processes of the art. The separation of carbon dioxide from the exhaust gases during energy generation with fossil fuels and subsequent underground storage or use in other processes is seen worldwide as an indispensable component in minimizing global warming. Due to the very low energy requirements of the CO₂ separation, the reactor is suitable for the worldwide implementation of CO₂ sequestration. In principle, the reactor can be installed behind all power plants and industrial plants such as cement and lime plants (responsible for 5% of the CO₂ emissions worldwide).

The aim of the method according to the invention is to reuse the reaction enthalpy released during carbonization directly in a reactor for the endothermic calcination. Therefore, there are appropriate materials in the reactor that store the heat. The exothermic and endothermic reaction enthalpies are of the same size. This eliminates both the annoying use of waste heat from carbonization and the laborious energy generation of calcination. Since, according to the second law of thermodynamics, heat can only flow from a higher to a lower temperature, the carbonization (CaO+CO₂→CaCO₃) must take place at a higher temperature level than the endothermic calcination (CaCO₃→CaO+CO₂)

The objects of the present invention have the following features and advantages:
A reconstruction of existing plants such as for example with Oxyfuel is not necessary. The solids reactor contains dolomite and/or limestone or lime particles, respectively, and inert inorganic material, for example gravel particles which can store heat. Phase change materials of the known type are also suitable. Dolomite has the advantage that the internal magnesite fraction already serves as a storage medium.
For absorption of the carbon dioxide according to CaO+CO₂—>CaCO₃ (carbonization), the exhaust gas is passed through the fixed bed under excess pressure. Thereby the temperature level of this carbonization reaction is increased.
The subsequent calcination (CaCO₃—>CaO+CO₂) is carried out under low pressure. Thereby the temperature level of this calcination reaction is lowered.
The CO₂ partial pressure of the exhaust gas must be higher during the carbonization than that of the pure gas of the CO₂ during the calcination, as shown in FIG. 2.
As a result, the exothermic carbonization takes place at a higher temperature level than the endothermic calcination.
The heat released during carbonization is stored in the inert material and can therefore subsequently be used for calcination.

In a particularly preferred embodiment of the present invention, lumpy limestones or dolomitic stones in the cm range are in the reactor. The area close to the surface absorbs the carbon dioxide (marked in FIG. 5 as a dark ring-shaped area with the stones shown as being spherical). The reaction enthalpy released during absorption is directed into the interior of the stones, thereby heating the stones. The reaction enthalpy is thus stored as latent enthalpy. The size of the stones is chosen so that the mass of the unreacted, inert core is sufficient to store the reaction enthalpy. Only an area close to the surface can absorb carbon dioxide, because the resulting increase in volume makes the shell of CaCO₃ impervious and then no further carbon dioxide can diffuse into the core.

Dolomitic stones are preferred as stones. On the one hand, the inert MgO fraction serves as a storage mass; on the other hand, the MgO fraction prevents the CaO fraction from sintering, so that many cycles can be carried out without the so-called dead burning of the lime occurring. In preliminary tests, over 500 cycles were carried out without a decrease in the absorption capacity taking place. In previous processes with particles in the μm range, the original absorption capacity had dropped to about 10% after 10 cycles.

After the pressure reduction for the calcination, the endothermic reaction enthalpy is then covered by the stored, latent enthalpy and the stones cool down again, as shown in FIG. 6.

According to the invention it is particularly advantageous that the stones used according to the invention in the reactor have a size in the cm range. This ensures that at the loading of the stones with carbon dioxide, which increases the volume of the stones, the passage of gases or fluids, respectively, is not disturbed. The size of the stones also effects that the number of cycles can be increased, since sintering is avoided. Stone sizes from 0.5 cm to 10 cm are preferred, very particularly preferably 2 cm to 5 cm.

The following embodiments explain the invention in more detail without restricting the scope of the invention.

The inventive basic idea of the method according to the invention is that the exhaust gas is compressed for the carbonization and that the subsequent calcination is carried out under low pressure. The pressure ratio must be set so that the CO₂ partial pressure during carbonization is above the CO₂ pressure during calcination. This principle is explained with FIG. 2. In this example it is assumed that the exhaust gas is compressed in such a way that the CO₂ partial pressure is 1 bar. An exhaust gas with 10% by volume of CO₂ would therefore have to be compressed to 10 bar. The calcination is carried out here at 0.2 bar absolute pressure. The associated equilibrium temperatures are 910° C. and 810° C. The carbonization can now be carried out in the temperature range from 810° C. to 910° C., since in this range the CO₂ partial pressure is always greater than the equilibrium pressure. In the same temperature range the calcination can also be carried out, since the condition for this, equilibrium pressure greater than CO₂ pressure, is met (see FIG. 2).

A solids reactor is used for the transfer of the heat from carbonization to calcination. According to FIG. 3, this consists of lime particles and inert solid particles, such as for example quartz particles. The inert particles are used to store the heat generated during carbonization. Depending on the temperature difference between carbonization and calcination, the volume ratio between the inert particles and the lime particles is 10 to 15. The smaller the temperature difference, the more inert particles are required for storage. In the example shown in FIG. 3, it is assumed that the fixed bed has a temperature of 850° C. after calcination. If an exhaust gas with for example 1 bar CO₂ partial pressure at 910° C. now flows in, the gas cools down. The partial pressure is then higher than the equilibrium pressure, so the CO₂ can be deposited on the lime particles. Due to the heat of the reaction, the fixed bed heats up to 910° C. over time. The partial pressure and temperature profiles that develop over time are shown schematically. Temperatures higher than 910° C. are not possible, since the reaction then comes to a standstill. The maximum temperature of the rector can be set via the CO₂ partial pressure. The higher this is, the higher the maximum possible temperature.

If the reactor is charged to 910° C., the exhaust gas flow is passed into another, discharged reactor (see FIG. 4 in this regard). The pressure in the loaded reactor is then reduced to 0.4 bar. The equilibrium pressure is now higher than the partial pressure, so that the reactive particles calcine. The process is analogous to the evaporation of water from a moist, porous body, the temperature of which is higher than the saturated steam temperature of the surrounding water vapor. During the evaporation, the porous body cools down in order to generate the enthalpy of evaporation. Analogously, the fixed bed cools down to the equilibrium temperature of 850° C. in order to generate the reaction enthalpy. The resulting CO₂ flow transfers the heat between the inert and reactive particles. If the CO₂ flow is not sufficient for heat transfer, CO₂ can be circulated, if necessary, to increase the flow in the reactor. After the discharge, the reactor is reloaded. So there is a regenerative enthalpy exchange.

In FIGS. 5 and 6, a further and particularly preferred embodiment of the reactor according to the invention is now shown. A solids reactor is used to transfer the heat from carbonization to calcination. According to FIG. 5, this consists of lumpy limestone and dolomitic rocks. The inert core is used to store the heat generated during carbonization. Depending on the temperature difference between carbonization and calcination, the volume ratio between the inert core and the reacting shell is 5 to 10. In the example shown in FIG. 5, it is assumed that the fixed bed has a temperature of 810° C. after calcination. If an exhaust gas with, for example, 1 bar CO₂ partial pressure at 910° C. now flows in, the gas cools down. The partial pressure is then higher than the equilibrium pressure, so the CO₂ can be separated. The heat of reaction causes the fixed bed to heat up to 910° C. over time. The partial pressure and temperature profiles that arise over time are shown schematically. Temperatures higher than 910° C. are not possible as the reaction then comes to a standstill. The maximum temperature of the rector can be set by means of the CO₂ partial pressure. The higher this is, the higher the maximum possible temperature.

If the reactor is charged to 910° C., the exhaust gas flow is passed into another, discharged reactor, as shown in FIG. 6. The pressure in the loaded reactor is then reduced to, for example, 0.2 bar. The equilibrium pressure is now higher than the partial pressure, so that the reactive stones calcine. The process is analogous to the evaporation of water from a moist, porous body, the temperature of which is higher than the saturated steam temperature of the surrounding water vapor. During the evaporation, the porous body cools down in order to generate the enthalpy of evaporation. Analogously, the fixed bed cools down to the equilibrium temperature of 810° C. in order to generate the reaction enthalpy. After the discharge, the reactor is reloaded. So, there is a regenerative enthalpy exchange.

In FIG. 7 a plant diagram 100 for the overall process is shown. For a better understanding of the process, the temperatures specified in this embodiment relate to the example that the carbonization is carried out at a CO₂ partial pressure of 1 bar and the calcination is carried out under pure CO₂ at 0.4 bar. All temperatures apply to an adiabatic, reversible ideal process. The exhaust gas 13 has a temperature of 20° C., the ambient pressure of 1 bar and 10% CO₂. A pressure of 10 bar and 910° C. is then required for carbonization. The exhaust gas 13 is therefore first compressed to 10 bar, the temperature rising to 293° C. The clean gas emerges from the carbonizer 1a at 850° C. This gas heats the exhaust gas to about 800° C. in a countercurrent recuperator 6. Natural gas 9 is required for the rest of the heating to 910° C. This natural gas flow 9 represents the main energy requirement of the overall process. The energy released when the clean gas is expanded is used for compression. As a result, only a relatively small electrical current is required for the compression of the exhaust gas. The carbon dioxide flow exits the calcination process at 850° C. This heat is used to generate electricity, e.g., by ORC 18. This electricity is sufficient to compress the carbon dioxide stream to ambient pressure.

The system according to the invention shown in FIG. 7 is described in more detail below. The fluid to be freed from carbon dioxide, namely the exhaust gas, is introduced into the system via exhaust gas inlet 13. The exhaust gas is compressed to the corresponding partial pressure of the CO₂ by means of the compressor 7 and passed through the countercurrent recuperator 6 via the inlet line 4. The exhaust gas heated as a result is introduced into the reactor 1a via the inlet 3 for carbonization. In the reactor 1a, the CO₂ is bound as calcium carbonate and the exhaust gas, which is now low in CO₂, is fed back into the countercurrent recuperator 6 via the outlet line 5. The now purified exhaust gas is released via an expansion device 8 under normal pressure via the exhaust gas outlet 14. In order to heat the exhaust gas 13 containing carbon dioxide to the required reaction temperature of 910° C., a fuel, e.g. natural gas, is introduced through the inlet 9, compressed in the compressor 10 to the reaction pressure (here 10 bar) and injected through the feed line 12 into the exhaust gas. The amount of fuel is so small that the oxygen in the exhaust gas is sufficient for combustion. As a result of the combustion, the oxygen content in the exhaust gas only decreases by about 1% to 1.5%. For stable combustion, air 11 can be compressed by means of compressor 10 and burned with natural gas 9. The combustion gas is then injected into the exhaust gas 13 via the gas supply line 12. Alternatively, part of the exhaust gas flow can be diverted for stable combustion. The natural gas is then injected into this diverted exhaust gas flow. The amount of the diverted exhaust gas flow is so large that the temperature rises above 1200° C., at which a complete combustion is guaranteed.

If the solids reactor 1 is now in state 1b of the unloading of the CO₂, the CO₂, which is bound in the calcium carbonate, is discharged from the outlet 2 during the cooling of the solids reactor. The CO₂ is cooled in the low-pressure heat exchanger 15, then brought to ambient pressure in the compressor 16 and cooled again in the normal pressure heat exchanger 17. The heat dissipated into the heat exchangers 15 and 17 is converted into electricity in the ORC system 18, which could also be a steam turbine. This electricity is used in the system for the compressors. Pure CO₂ now exhausts through outlet 19 under normal conditions. By the energetic coupling of the fluid flows a high level of energy efficiency is achieved, so that only a small amount of energy has to be introduced into the system from the outside in order to be able to carry out the respective reaction processes of carbonization and calcination.

In FIG. 8, a second embodiment of the system according to the invention is shown. In FIG. 8 a system diagram 100 for the entire process is shown. For a better understanding of the process, the temperatures specified in this embodiment relate to the example that the carbonization is carried out at a CO₂ partial pressure of 1 bar and the calcination under pure CO₂ at 0.2 bar. All temperatures apply to an adiabatic, reversible ideal process. The exhaust gas 13 has a temperature of 20° C., the ambient pressure of 1 bar and 10% CO₂. A pressure of 10 bar and 910° C. is then required for carbonization. The exhaust gas 13 is therefore initially compressed to 10 bar, the temperature rising to 293° C. The clean gas emerges from the carbonizer 1a at 810° C. This gas heats the exhaust gas to about 700° C. in a countercurrent recuperator 6. For the remaining heating to 910° C., electrical energy can be used via heat elements, hydrogen can be injected and burned if there is still some oxygen in the exhaust gas, or a combustion gas can be injected. The latter would, however, generate additional carbon dioxide. This gas flow 9 represents the main energy requirement of the overall process. The energy released when the clean gas is relieved is used for compression. As a result, only a relatively small amount of electrical power is required to compress the exhaust gas. The carbon dioxide stream exits the calcination process with 810° C. This heat could be used, for example, to generate electricity, e.g. by ORC 18.

The system according to the invention shown in FIG. 8 is described in more detail below. The fluid to be freed of carbon dioxide, namely the exhaust gas, is introduced into the system via the exhaust gas inlet 13. The exhaust gas is compressed to the corresponding partial pressure of the CO₂ by means of the compressor 7 and passed through the countercurrent recuperator 6 via the inlet line 4. The exhaust gas heated as a result is introduced into the reactor 1a for carbonization via the inlet 3. In the reactor 1a, the CO₂ is bound as calcium carbonate and the exhaust gas, which is now low in CO₂, is fed back into the countercurrent recuperator 6 via the outlet line 5. The now purified exhaust gas is discharged via an expansion device 8 under normal pressure via the exhaust gas outlet 13. In order to heat the exhaust gas 14 containing carbon dioxide to the required reaction temperature of 910° C., hydrogen can be injected via lances 21, the gas can flow through electrical heating coils 22 or a hot combustion gas can be injected via lances 12.

If the solids reactor 1 is now in state 1b of the unloading of the CO₂, the CO₂, which is bound in the calcium carbonate, is discharged during the cooling of the solids reactor therefrom via outlet 2. The CO₂ is cooled in the low-pressure heat exchanger 15, then brought to ambient pressure in the compressor 16 and cooled again in the normal-pressure heat exchanger 17. Pure CO₂ now exhausts through the outlet 19 under normal conditions. The energetic coupling of the gas streams achieves a high level of energy efficiency, so that only a small amount of energy has to be introduced from outside into the system in order to be able to carry out the corresponding reaction processes of carbonization and calcination.

In FIG. 9 a partial view of a system according to the invention in a first embodiment is shown. The solids reactors 1 are arranged parallel to one another and each fluidically connected with the inlet 3, the outlet line 5 and the outlet 2, with shut-off devices 20 being arranged in such a way to connect each of the two reactors independently to the lines 3 and 5 for the carbonization process, or to connect with outlet 2 for the calcination process. It is thus possible, to operate the respective solids reactors 1, which can be in different operating states, separately. This means that one of the fixed bed reactors is in state 1a of loading with CO₂, while the other fixed bed reactor is in state 1b of discharging the CO₂. In other embodiments of the present invention, further fixed bed reactors 1 can be provided, each of the reactors being operated in one of the states 1a or 1b (not shown). It is also provided according to the invention that further solids reactors can be arranged accordingly, the number of which does not have to be limited according to the invention.

### LIST OF REFERENCE NUMERALS

1 Solid reactor
1a Solid reactor in the state of loading with CO₂
1b Solid reactor in the state of discharging the CO₂
2 Outlet
3 Inlet
4 Inlet line
5 Outlet line
6 Countercurrent recuperator
7 Compressor for exhaust gas
8 Expansion device for clean gas
9 Fuel gas supply
10 Compressor
11 Air supply
12 Combustion gas supply
13 Exhaust gas inlet or outlet
14 Exhaust gas outlet (low CO₂)
15 Low pressure heat exchanger
16 Compressor for CO₂
17 Normal pressure heat exchanger
18 ORC system for power generation
19 CO₂ outlet
20 Shut-off devices
21 Hydrogen injection
22 Electric heating
100 System for storing and releasing carbon dioxide

1. Solid reactor for storage and releasing carbon dioxide, comprising a fluid-tight housing, which has an interior, at least one inlet for feeding in fluids and at least one outlet for discharging of fluids, wherein the interior of the housing is filled with at least two different solids, wherein one solid is provided for storing thermal energy and the other solid is provided for reversible storage and release of carbon dioxide.

2. The solids reactor according to claim 1, wherein the housing further comprises components which are constructed for introducing or discharging the solids.

3. The solids reactor according to claim 1, characterized in that the area of the inlet and in the area of the outlet of fluids shut-off devices are arranged, which are constructed to change the pressure in the interior of the solids reactor, and/or to introduce fluids into the solids reactor and/or to discharge fluids that escape from the solids reactor.

4. The solids reactor according to claim 1, characterized in that the solids for the storage and releasing of carbon dioxide are selected from calcium oxide and calcium oxide-containing substances selected from limestones and dolomites.

5. The solids reactor according to claim 1, characterized in that the solids for storing thermal energy are selected from inert mineral materials such as quartz, granite, silicon dioxide, igneous rocks, silicon carbides, zirconium oxides, metallic phase change materials, cast iron, grey cast iron or mixtures of the solids mentioned.

6. The solids reactor according to claim 1, characterized in that the at least different solids are in the form of coated solids, consisting of an outer coating and an inner core, wherein the inner core is intended to store the thermal energy and the outer coating is provided for the reversible storage and release of carbon dioxide.

7. The solids reactor according to claim 1, characterized in that the at least two different solids are in form of double salts, wherein one of the salts of the double salt is suitable for storing thermal energy and the other salt of the double salt is suitable for reversible storage and release of carbon dioxide.

8. The solids reactor according to claim 6, characterized in that the double salts are selected from dolomite, dolomite stone, dolomitic rocks, rocks containing dolomite or dolomite stone, or mixtures the thereof.

9. The solids reactor according to claim 1, characterized in that the at least two different solids have a particle size which is in the cm range.

10. The solids reactor according to claim 1, characterized in that the solids introduced into the solids reactor form a fixed bed that allows through-flow.

11. System for storing and releasing carbon dioxide, comprising at least one solids reactor according to claim 1, at least one compressor for compressing the carbon dioxide-containing fluid, which is introduced through the inlet of the solids reactor, wherein the compressor is constructed in such a way that it adiabatically expands the fluid depleted of carbon dioxide that is discharged from the reactor by means of the outlet of the solids reactor, and
at least one countercurrent recuperator, which is constructed for the heat exchange of the compressed fluid that contains carbon dioxide and of the fluid depleted of carbon dioxide.

12. The system according to claim 11, characterized in that in the area of the inlet at least one supply for heated fluids is arranged, to further heat the carbon dioxide-containing fluid after heating in the counter-current recuperator and before entering the inlet of the solids reactor.

13. The system according to claim 12, characterized in that, one or more compressors is/are provided which compress or compresses and burn air and/or natural gas and/or heating oil and inject the combustion gas via the supply device.

14. The system according to claim 12, characterized in that the supply device is electrically heatable, and in that the introduced fluid is hydrogen gas.

15. The system according to claim 11, characterized in that furthermore pipelines and shut-off devices are provided, which allow the solids reactor to be constructed to be decoupled from the system, and which connect the solids reactor fluidically via the outlet to the recuperator for discharging fluids.

16. The system according to claim 11, characterized in that system has at least two solids reactors, wherein the solids reactors are fluidically connected with components of systems in that the respective solids reactors are provided independently of one another for storage and for releasing of carbon dioxide.

17. Method for storage and releasing of carbon dioxide, wherein one
a) provides at least one solids reactor according to claim 1, for storage and releasing of carbon dioxide,
b) introduces a carbon dioxide-containing fluid in the solids reactor, wherein one compresses the fluid in a way that the partial pressure of the carbon dioxide is 1 to 2 bar,
c) stops the introducing of the carbon dioxide-containing fluid, when the temperature in the interior of the solids reactor is 910 to 960° C.,
d) releases the tension of the solids reactor to a pressure of 0.1 bis 0.5 after reaching the internal temperature of 910° C. to 960° C.;
e) discharges the carbon dioxide released again by the expansion from the solids reactor until the temperature inside the solids reactor is 810 to 850° C.,
f) compresses the discharged carbon dioxide to normal pressure and stores it.

18. The method according to claim 17, characterized in that the partial pressure of the carbon dioxide in step b) is above 1 bar.

19. The method according to claim 17, characterized in that the pressure in the interior of the solids reactor in step d) is less than 0.4 bar, especially preferred less than 0.2 bar.

20. The method according to claim 17, characterized in that the temperature in the interior of the solids reactor in step c) is more than 910° C.

21. The method according to claim 17, characterized in that the temperature in the interior of the solids reactor in step e) is below 850° C.

22. The method according to claim 17, characterized in that storage of the carbon dioxide and the subsequent release take place in the same temperature range and in the same reactor.

23. The method according to claim 17, characterized in that the enthalpy released during carbon dioxide absorption or during storage, causes the increase in temperature and thereby is stored in the material which remains inert.

24. The method according to claim 17, characterized in that the stored heat is reused after the pressure reduction for the releasing of the carbon dioxide.
